(19) United States
(12) Patent Application Publication
(10) Pub. No.: US 2010/0245266 A1
(43) Pub. Date: Sep. 30, 2010

(54) HANDWRITING PROCESSING APPARATUS, COMPUTER PROGRAM PRODUCT, AND METHOD

(75) Inventors: Yojiro Tonouchi, Tokyo (JP); Ryuzo Okada, Tokyo (JP); Mieko Asano, Tokyo (JP); Hiroshi Hattori, Tokyo (JP); Tsukasa Ike, Tokyo (JP); Akihito Seki, Tokyo (JP); Hidetaka Ohira, Tokyo (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/559,840

(22) Filed: Sep. 15, 2009

(30) Foreign Application Priority Data
Mar. 27, 2009 (JP) 2009-078115

(51) Int. Cl. G06F 3/041

(52) U.S. Cl. 345/173; 382/187

(57) ABSTRACT

A handwriting processing apparatus includes an acquiring unit configured to acquire coordinate information of handwriting input by an input unit and attribute information, the attribute information indicating a type of input of the handwriting; a determining unit configured to determined a kind of the handwriting using the attribute information; a handwriting processing unit configured to perform handwriting processing corresponding to the kind of the handwriting using the coordinate information; and a display control unit configured to control a display unit to display a result of the handwriting processing.

### CROSS-REFERENCE TO RELATED APPLICATIONS

This application is based upon and claims the benefit of priority from the prior Japanese Patent Application No. 2009-078115, filed on Mar. 27, 2009; the entire contents of which are incorporated herein by reference.

### BACKGROUND OF THE INVENTION

1. Field of the Invention

The present invention relates to a handwriting processing apparatus, a computer program product, and a method.

2. Description of the Related Art

Electronic apparatuses have been known which are provided with coordinate input devices, such as touch pads or touch panels. Those apparatuses are operated and input data using the trajectory of a finger, a pen, or the like. In recent years, a so-called multi-touch coordinate input device has been proposed. When instructions (touches) are given to plural points using a finger or a pen, the input device can detect the coordinates of the plural instruction points at the same time (for example, see JP-A 2007-184008 (KOKAI))

The electronic apparatuses use the trajectory of the finger or the pen to input a character or a gesture for performing a predetermined operation, such as the movement of a cursor. When the shape of a character is similar to that of a gesture, it is difficult to determine whether input handwriting indicates a character or a gesture.

JP-A 2003-196593 (KOKAI) discloses to separately provide a region for inputting a character and a region for inputting a gesture. The character input and the gesture input are switched depending on to which region an input is performed.

However, with the above-mentioned related art, a finger or a pen needs to be moved to another region in order to perform the input switching. Therefore, there is room for improvement in terms of usability.

### SUMMARY OF THE INVENTION

According to one aspect of the present invention, a handwriting processing apparatus includes an acquiring unit configured to acquire coordinate information of handwriting input by an input unit and attribute information, the attribute information indicating a type of input of the handwriting; a determining unit configured to determine a kind of the handwriting using the attribute information; a handwriting processing unit configured to perform a character recognizing process or a gesture recognizing process corresponding to the kind of the handwriting using the coordinate information; and a display control unit configured to control a display unit to display a character recognized if the character recognizing process is performed, and control the display unit to display a execution result of the commend if the gesture recognizing process is performed.

According to another aspect of the present invention, a computer program product has a computer readable medium including programmed instructions for processing handwriting that, when executed by a computer, causes the computer to perform acquiring coordinate information of handwriting input by an input unit and attribute information, the attribute information indicating a type of input of the handwriting; determining a kind of the handwriting using the attribute information; performing a character recognizing process or a gesture recognizing process corresponding to the kind of the handwriting using the coordinate information; and causing a display unit to display a character recognized if the character recognizing process is performed, and control the display unit to display a execution result of the commend if the gesture recognizing process is performed.

According to still another aspect of the invention, a handwriting processing method includes acquiring coordinate information of handwriting input by an input unit and attribute information, the attribute information indicating a type of input of the handwriting; determining a kind of the handwriting using the attribute information; performing a character recognizing process or a gesture recognizing process corresponding to the kind of the handwriting using the coordinate information; and causing a display unit to display a character recognized if the character recognizing process is performed, and control the display unit to display a execution result of the commend if the gesture recognizing process is performed.

### BRIEF DESCRIPTION OF THE DRAWINGS

FIG. 1 is a block diagram illustrating an example configuration of a handwriting processing apparatus according to a first embodiment;

FIG. 2 is a diagram illustrating an example of coordinate information acquired by an acquiring unit according to the first embodiment;

FIG. 3 is a diagram illustrating an example of handwriting input by a single finger of a user;

FIG. 4 is a diagram illustrating an example of handwriting input by a plurality of fingers of the user;

FIG. 5 is a diagram illustrating an example of information stored in a gesture-recognition data storage unit according to the first embodiment;

FIG. 6 is a flowchart illustrating an example procedure of a handwriting process performed by the handwriting processing apparatus according to the first embodiment;

FIG. 7 is a block diagram illustrating an example configuration of a handwriting processing apparatus according to a second embodiment;

FIG. 8 is a flowchart illustrating an example procedure of a handwriting process performed by the handwriting processing apparatus according to the second embodiment;

FIG. 9 is a block diagram illustrating an example configuration of a handwriting processing apparatus according to a third embodiment;

FIG. 10 is a flowchart illustrating an example procedure of a handwriting process performed by the handwriting processing apparatus according to the third embodiment;

FIG. 11 is a block diagram illustrating an example configuration of a handwriting processing apparatus according to a fourth embodiment; and

FIG. 12 is a flowchart illustrating an example procedure of a handwriting process performed by the handwriting processing apparatus according to the fourth embodiment.

### DETAILED DESCRIPTION OF THE INVENTION

Hereinafter, exemplary embodiments of a handwriting processing apparatus, a computer program product, and a method according to the invention will be described in detail with reference to the accompanying drawings.

In a first embodiment, an example of determining whether the kind of handwriting is a character or a gesture depending on whether pieces of handwriting are input at the same time will be described.

In the first embodiment, a user uses the user's finger to input handwriting. When inputting a character, the user uses a single finger to input handwriting. When inputting a gesture, the user uses a plurality of fingers to input handwriting. When the number of input handwriting pieces is one, a handwriting processing apparatus according to the first embodiment determines that the kind of handwriting is a character. When a plurality of handwriting pieces are input at the same time, the handwriting processing apparatus determines that the kind of handwriting is a gesture.

First, the configuration of the handwriting processing apparatus according to the first embodiment will be described.

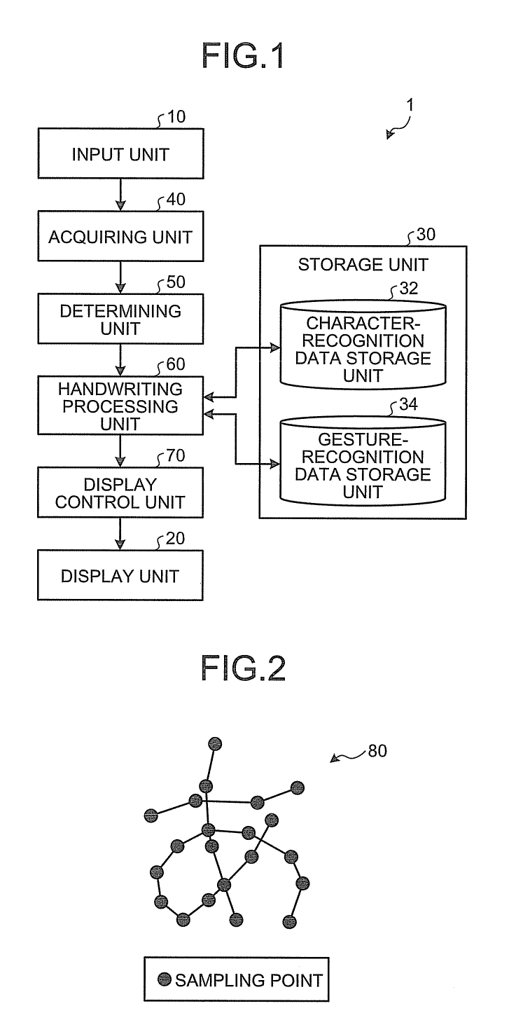

As shown in FIG. 1, the handwriting processing apparatus 1 includes an input unit 10, a display unit 20, a storage unit 30, an acquiring unit 40, a determining unit 50, a handwriting processing unit 60, and a display control unit 70.

The input unit 10 is used by the user to input handwriting with the finger or the like, and can be implemented by a conventional coordinate input device, such as a touch pad, a touch panel, or a tablet. The input unit 10 according to the first embodiment is implemented by a so-called multi-touch coordinate input device capable of simultaneously detecting the coordinates of a plurality of instruction points, and can detect the number of handwriting pieces that are input at the same time.

The display unit 20 displays, for example, the handwriting process result of the handwriting processing unit 60, which will be described later, under the control of the display control unit 70, which will be described later. The display unit can be implemented by a conventional display device, such as a CRT display, a liquid crystal display, a plasma display, an organic EL display, or a touch panel display.

The storage unit 30 stores various information items used by the handwriting processing apparatus 1, and can be implemented by a conventional storage medium capable of magnetically, electrically, or optically storing data, such as an hard disk drive (HDD), an solid state drive (SSD), a memory card, an optical disk, or a RAM (random access memory). The storage unit 30 includes a character-recognition data storage unit 32 and a gesture-recognition data storage unit 34. These storage units will be described later.

The acquiring unit 40 acquires coordinate information of handwriting input by the input unit 10 and attribute information that indicates the type of input of the handwriting. Specifically, the acquiring unit 40 acquires the coordinate information of handwriting and the attribute information of the handwriting at predetermined time intervals over a period during which a finger is directed to (in contact with) an input surface of the input unit 10 to input handwriting.

In an example illustrated in FIG. 2, the acquiring unit 40 acquires through time the coordinates of sampling points shown in FIG. 2 in a handwritten character 80 input by the input unit 10.

The coordinate information of handwriting acquired by the acquiring unit 40 contains two-dimensional coordinates on the input surface of the input unit 10, and the attribute information of handwriting acquired by the acquiring unit 40 indicates whether a plurality of handwriting pieces are input at the same time.

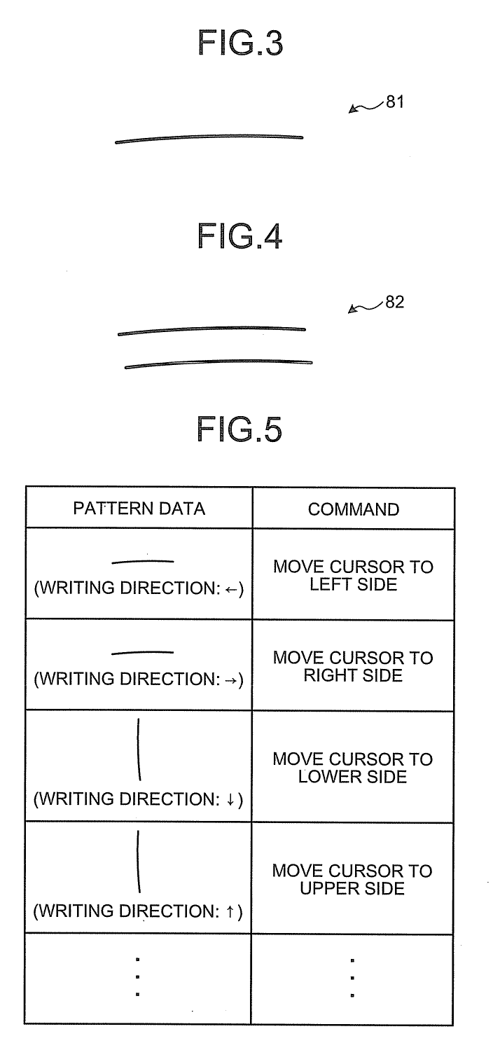

In an example shown in FIG. 3, since the user uses a single finger to input a handwriting piece 81, the attribute information acquired by the acquiring unit 40 indicates a “single input”. In an example shown in FIG. 4, since the user uses a plurality of fingers to simultaneously input handwriting pieces 82, the attribute information acquired by the acquiring unit 40 indicates a “plural inputs”.

The input unit 10 according to the first embodiment detects the coordinates of a plurality of instruction points at the same time. The acquiring unit 40 may acquire the coordinates of respective handwriting pieces as individual values. Alternatively, the acquiring unit 40 may acquire the average value of the coordinates of a plurality of handwriting pieces as the coordinate information.

When the acquiring unit 40 acquires the coordinates of respective handwriting pieces as individual values, the coordinate information at a certain time may be represented as follows: (x[1], y[1]), (x[2], y[2]), . . . , (x[P], y[P]) (where P is a natural number and indicates the number of handwritings that are input at the same time). When the acquiring unit 40 acquires the average value of the coordinates of a plurality of handwriting pieces, the coordinate information (x, y) may be represented by the following Expressions 1 and 2:

X=(x[1]+x[2]+ . . . +x[P])/P (1)

Y=(y[1]+y[2]+ . . . +y[P])/P (2)

The determining unit 50 determines the kind of handwriting using the attribute information acquired by the acquiring unit 40. Specifically, the determining unit 50 determines whether the kind of handwriting is a character or a gesture for performing a predetermined process using the attribute information acquired by the acquiring unit 40.

In the first embodiment, when the attribute information indicates a “single input”, the determining unit 50 determines that the kind of handwriting is a character. When the attribute information indicates a “plural inputs”, the determining unit 50 determines that the kind of handwriting is a gesture.

The character-recognition data storage unit 32 stores, for example, character recognizing pattern data that is used in a character recognizing process performed by the handwriting processing unit 60, which will be described later.

The gesture-recognition data storage unit 34 stores, for example, gesture recognizing pattern data that is used in a gesture recognizing process performed by the handwriting processing unit 60. In addition, commands executed by the handwriting processing unit 60 are included in and associated with the gesture recognizing pattern data.

In an example shown in FIG. 5, pattern data indicating a gesture for moving a cursor and commands for moving the cursor are stored in the gesture-recognition data storage unit 34 so as to be associated with each other. FIG. 5 shows pattern data when the acquiring unit 40 acquires the average value of a plurality of coordinates.

The handwriting processing unit 60 uses the coordinate information acquired by the acquiring unit 40 to perform a handwriting process corresponding to the determination result of the determining unit 50. Specifically, when the determining unit 50 determines that the kind of handwriting is a character, the handwriting processing unit 60 uses the coordinate information to perform a character recognizing process. When the determining unit 50 determines that the kind of handwriting is a gesture, the handwriting processing unit 60 uses the coordinate information to perform a gesture recognizing process, and performs the process indicated by the recognized gesture.

In the character recognizing process, the handwriting processing unit 60 performs pattern matching between the coordinate information and the pattern data stored in the character-recognition data storage unit 32, and recognizes a character corresponding to the input handwriting. For example, the method disclosed in JP-A 2002-203208 (KOKAI) may be used for the character recognizing process.

In the gesture recognizing process, the handwriting processing unit 60 performs pattern matching between the coordinate information and the pattern data stored in the gesture-recognition data storage unit 34 to recognize a gesture corresponding to the input handwriting, and executes the command associated with the recognized gesture (the movement of the cursor in the example shown in FIG. 5). For example, the method disclosed in JP-A 2008-250374 (KOKAI) may be used for the gesture recognizing process.

The handwriting processing unit 60 performs the character recognizing process or the gesture recognizing process while accumulating the coordinate information corresponding to one image or one character (handwriting information of a plurality of images). The term “coordinate information corresponding to one image” means handwriting during the period from the contact of a finger or a pen with the input surface of the input unit 10 to the separation of the finger or the pen from the input surface, and the coordinate information may be represented as follows: (X[1], Y[1]), (X[2], Y[2]), . . . , (X[K], Y[K]) (where K is a natural number). X[i], Y[i] (0≦i≦K) indicates the coordinates of handwriting corresponding to one image at a certain time (where i is an index of time).

The display control unit 70 controls the display unit 20 to display the handwriting process result of the handwriting processing unit 60. Specifically, when the handwriting processing unit 60 performs the character recognizing process, the display control unit 70 controls the display unit 20 to display the recognized character. When the handwriting processing unit 60 performs the gesture recognizing process, the display control unit 70 controls the display unit 20 to display the execution result of the commend (for example, when the cursor is moved, display unit 20 displays the screen after the movement of the cursor).

The acquiring unit 40, the determining unit 50, the handwriting processing unit 60, and the display control unit 70 may be implemented by a conventional control device that includes components, such as a central processing unit (CPU) and an application specific integrated circuit (ASIC).

Next, the operation of the handwriting processing apparatus according to the first embodiment will be described.

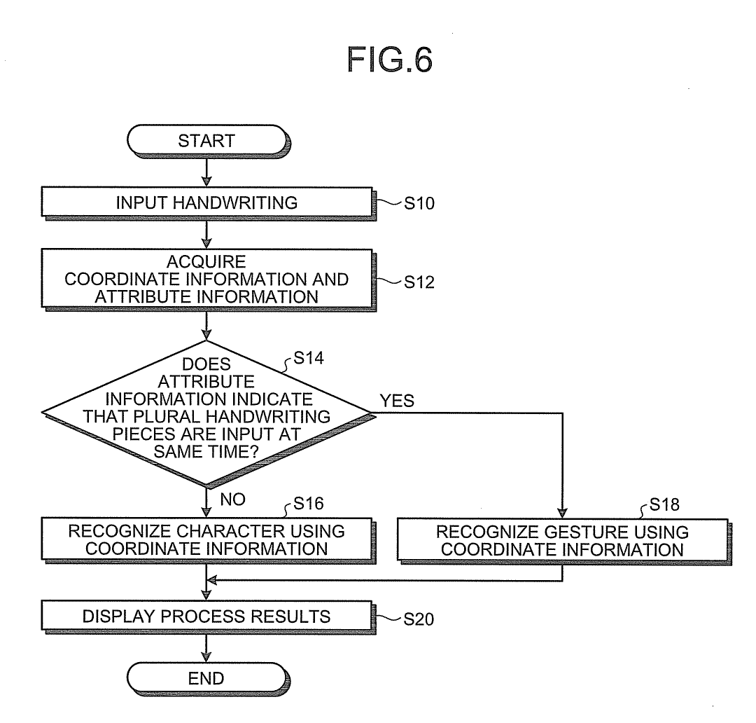

In Step S10 shown in FIG. 6, the user uses the finger to input handwriting to the input unit 10.

In Step S12, the acquiring unit 40 acquires the coordinate information of the handwriting input by the input unit 10 and the attribute information that indicates whether a plurality of handwriting pieces are input at the same time.

In Step S14, the determining unit 50 determines whether the kind of handwriting is a character or a gesture for performing a predetermined operation using the attribute information acquired by the acquiring unit 40. When the attribute information indicates a “single input” (No in Step S14), the process proceeds to Step S16. When the attribute information indicates a “plural inputs” (Yes in Step S14), the process proceeds to Step S18.

In Step S16, the handwriting processing unit 60 uses the coordinate information acquired by the acquiring unit 40 to perform the character recognizing process while referring to the pattern data stored in the character-recognition data storage unit 32.

In Step S18, the handwriting processing unit 60 uses the coordinate information acquired by the acquiring unit 40 to perform the gesture recognizing process while referring to the pattern data stored in the gesture-recognition data storage unit 34, and executes the command associated with the recognized gesture.

In Step S20, the display control unit 70 controls the display unit 20 to display the process result of the handwriting processing unit 60.

In the first embodiment, it is determined whether the kind of handwriting is a character or a gesture depending on whether a plurality of handwriting pieces are input at the same time, and the character recognizing process or the gesture recognizing process is performed in accordance with the determination result. Therefore, it is possible to determine the kind of input handwriting without lowering usability.

Next, in a second embodiment, an example of determining whether the kind of handwriting is a character or a gesture using coordinate information in addition to information on whether a plurality of handwriting pieces are input at the same time will be described.

Concerning the second embodiment, the difference from the first embodiment will be mainly described. In addition, components having the same functions as those in the first embodiment are given the same names and reference numerals as those in the first embodiment, and a description thereof will be omitted.

First, the configuration of a handwriting processing apparatus according to the second embodiment will be described.

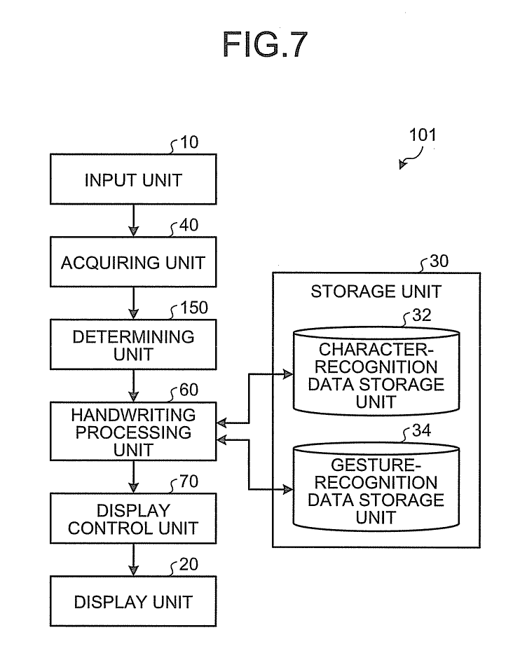

A handwriting processing apparatus 101 shown in FIG. 7 is different from the handwriting processing apparatus 1 according to the first embodiment in that a determining unit 150 determines whether the kind of handwriting is a character or a gesture using the coordinate information in addition to the attribute information acquired by the acquiring unit 40.

The determining unit 150, which is the main difference between the first embodiment and the second embodiment, will be described below.

When the attribute information acquired by the acquiring unit 40 indicates a “plural inputs”, the determining unit 150 determines whether the distance between the handwriting pieces that are input at the same time is greater than a threshold value on the basis of the coordinate information of each of the handwritings. Then, the determining unit 150 determines whether the kind of handwriting is a character or a gesture depending on whether the distance between the handwritings is greater than the threshold value.

For example, when the acquiring unit 40 acquires the coordinate information of two handwriting pieces, the coordinate information at a certain time is (x[1], y[1]), (x[2], y[2]). Therefore, the determining unit 150 can calculate the distance R between two handwriting pieces at a certain time using Expression 3 given below:

$$R = \sqrt{( x [ 1 ] - x [ 2 ] ) ( x [ 1 ] - x [ 2 ] ) + ( y [ 1 ] - y [ 2 ] ) ( y [ 1 ] - y [ 2 ] )} \qquad ( 3 )$$

Expression 3 indicates the Euclidean distance between two handwriting pieces at a certain time.

Specifically, the determining unit 150 calculates the distance between two handwriting pieces through time on the basis of the coordinate information of each of the handwriting pieces acquired at the same time using Expression 3 during the period from the input of the two handwriting pieces to the end of the input. Then, the determining unit 150 determines whether the longest distance between the two handwriting pieces is greater than the threshold value, and determines whether the kind of handwriting is a character or a gesture depending on whether the distance is greater than the threshold value.

In the second embodiment, when the attribute information indicates a “plural inputs” and the distance between the handwriting pieces is greater than the threshold value, the determining unit 150 determines that the kind of handwriting is a gesture. In the other cases, the determining unit 150 determines that the kind of handwriting is a character. The threshold value may be set to an appropriate value.

Next, the operation of the handwriting processing apparatus according to the second embodiment will be described.

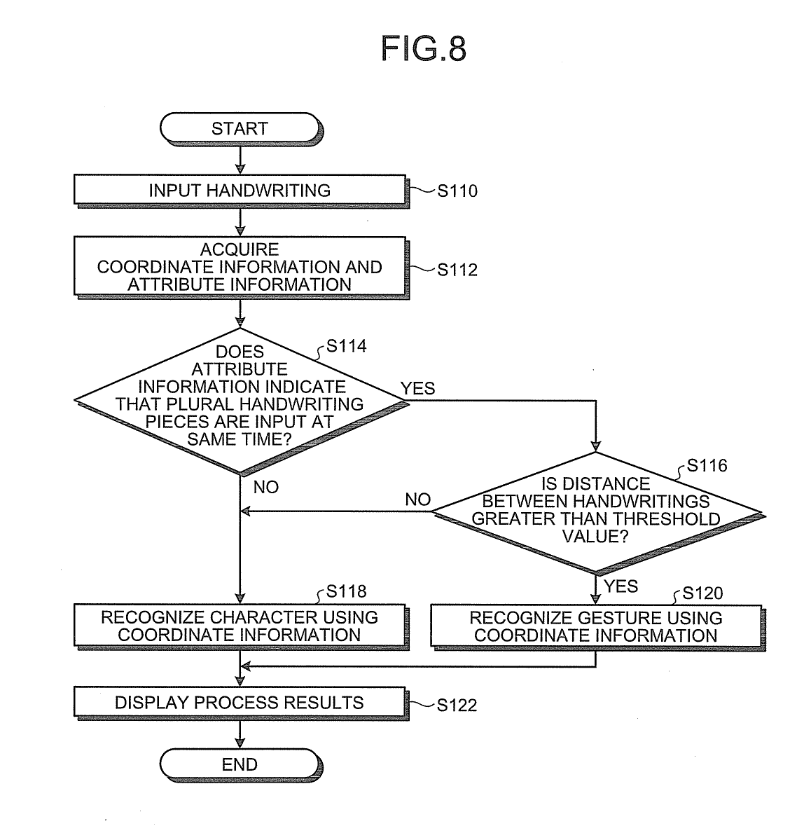

The process from Step S110 to Step S112 shown in FIG. 8 is the same as that from Step S10 to Step S12 of the flowchart shown in FIG. 6, and a description thereof will be omitted.

In Step S114, the determining unit 150 determines whether the kind of handwriting is a character or a gesture using the attribute information acquired by the acquiring unit 40. When the attribute information indicates a “single input” (No in Step S114), the process proceeds to Step S118. When the attribute information indicates a “plurality inputs” (Yes in Step S114), the process proceeds to Step S116.

In Step S116, the determining unit 150 determines whether the distance between the handwriting pieces that are input at the same time is greater than the threshold value on the basis of the coordinate information of each of the handwriting pieces. If it is determined that the distance is greater than the threshold value (Yes in Step S116), the process proceeds to Step S120. If it is determined that the distance is not greater than the threshold value (No in Step S116), the process proceeds to Step S118.

The process from Step S118 to Step S122 is the same as that from Step S16 to Step S20 of the flowchart shown in FIG. 6, and a description thereof will be omitted.

In the second embodiment, it is determined whether the kind of handwriting is a character or a gesture using the distance between the handwriting pieces in addition to information on whether a plurality of handwriting pieces are input at the same time, and the character recognizing process or the gesture recognizing process is performed depending on the determination result. Therefore, it is possible to more appropriately determine the kind of input handwriting without lowering usability.

Next, in a third embodiment, an example of determining whether the kind of handwriting is a character or a gesture depending on whether handwriting is input by a finger or a predetermined device, such as a pen, will be described.

Concerning the third embodiment, the difference from the first embodiment will be mainly described. In addition, components having the same functions as those in the first embodiment are given the same names and reference numerals as those in the first embodiment, and a description thereof will be omitted.

First, the configuration of a handwriting processing apparatus according to the third embodiment will be described.

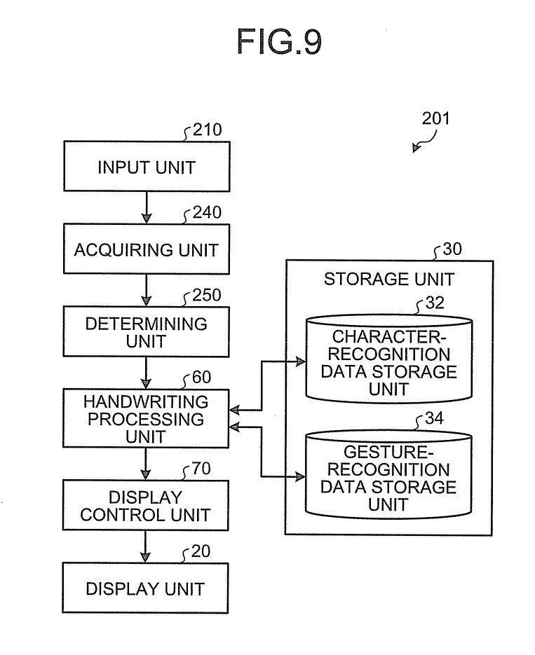

A handwriting processing apparatus 201 shown in FIG. 9 is different from the handwriting processing apparatus 1 according to the first embodiment in the processes performed by an input unit 210, an acquiring unit 240, and a determining unit 250.

The input unit 210, the acquiring unit 240, and the determining unit 250, which are the main difference between the first embodiment and the third embodiment, will be described below.

The input unit 210 according to the third embodiment is implemented by a coordinate input device that can detect an input by the finger and an input by a predetermined device, such as a pen. For example, the coordinate input device may be obtained by providing a capacitance-type sensor capable of detecting an input by the finger and an electromagnetic-induction-type sensor capable of detecting an input by a pen so as to overlap each other in the input surface.

The acquiring unit 240 acquires the coordinate information of the handwriting input by the input unit 210 and the attribute information that indicates the type of input of the handwriting. In third embodiment, the attribute information indicates whether handwriting is input by the finger or the pen.

In the third embodiment, when the attribute information indicates that handwriting is input by the finger, the determining unit 250 determines that the kind of handwriting is a gesture. When the attribute information indicates that handwriting is input by the pen, the determining unit 250 determines that the kind of handwriting is a character.

Next, the operation of the handwriting processing apparatus according to the third embodiment will be described.

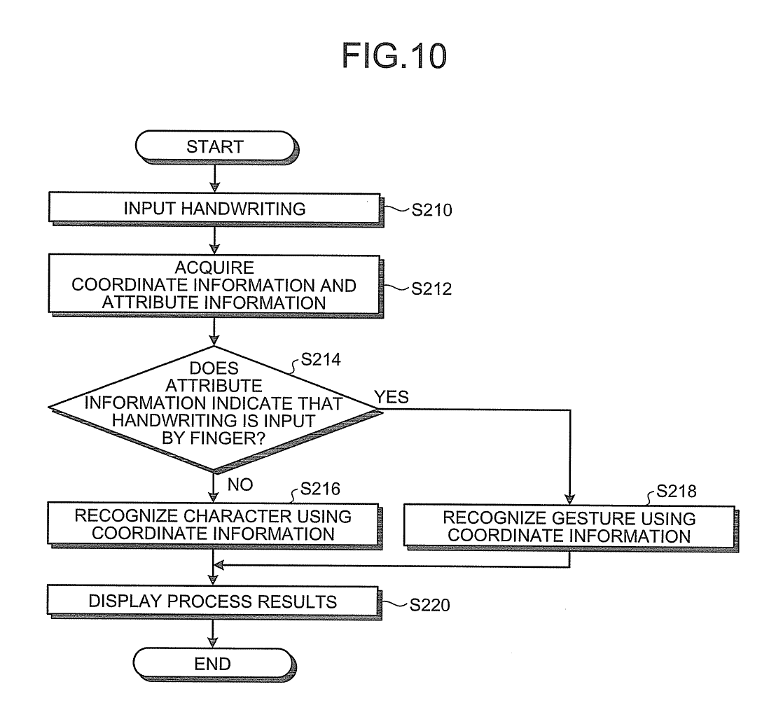

In Step S210 shown in FIG. 10, the user uses a finger or a pen to input handwriting to the input unit 210.

In Step S212, the acquiring unit 240 acquires the coordinate information of the handwriting input by the input unit 210 and the attribute information that indicates whether the handwriting is input by the finger or the pen.

In Step S214, the determining unit 250 determines whether the kind of handwriting is a character or a gesture using the attribute information acquired by the acquiring unit 240. When the attribute information indicates that handwriting is input by the finger (Yes in Step S214), the process proceeds to Step S218. When the attribute information indicates that handwriting is input by the pen (No in Step S214), the process proceeds to Step S216.

The process from Step S216 to Step S220 is the same as that from Step S16 to Step S20 of the flowchart shown in FIG. 6, and thus a description thereof will be omitted.

In the third embodiment, it is determined whether the kind of handwriting is a character or a gesture depending on whether handwritings is input by the finger or the pen, and the character recognizing process or the gesture recognizing process is performed in accordance with the determination result. Therefore, it is possible to determine the kind of input handwriting without lowering usability.

Next, in a fourth embodiment, an example of determining whether the kind of handwriting is a character or a gesture depending on whether the user touches the input surface to input handwriting will be described below.

Concerning the fourth embodiment, the difference from the first embodiment will be mainly described. In addition, components having the same functions as those in the first embodiment are given the same names and reference numerals as those in the first embodiment, and a description thereof will be omitted.

First, the configuration of a handwriting processing apparatus according to the fourth embodiment will be described.

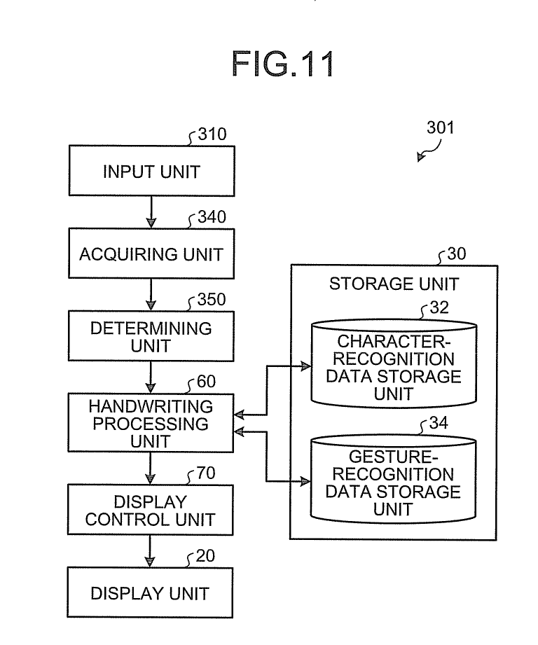

A handwriting processing apparatus 301 shown in FIG. 11 is different from the handwriting processing apparatus 1 according to the first embodiment in the processes performed by an input unit 310, an acquiring unit 340, and a determining unit 350.

The input unit 310, the acquiring unit 340, and the determining unit 350, which are the main difference between the first embodiment and the fourth embodiment, will be described below.

The input unit 310 according to the fourth embodiment is implemented by a coordinate input device capable of detecting whether the user touches the input surface to input handwriting. For example, the coordinate input device may be obtained by providing in the input surface a sensor capable of three-dimensionally detecting the coordinate information. The coordinate input device may acquire a value, such as writing pressure information, the touch area of the finger, or a height from the input surface, in addition to the coordinate information. The input unit 310 determines whether the user touches the input surface to input handwriting using any one of the acquired values. Alternatively, the input unit 310 may determine whether the kind of handwriting is a character or a gesture using the value, such as writing pressure information, the touch area of the finger, or a height from the input surface, without determining whether the user touches the input surface to input handwriting.

The acquiring unit 340 acquires the coordinate information of the handwriting input by the input unit 310 and the attribute information that indicates the type of input of the handwriting. In the fourth embodiment, the attribute information indicates whether the user touches the input surface of the input unit 310 to input handwriting.

In the fourth embodiment, when the attribute information indicates that the user touches the input surface to input handwriting, the determining unit 350 determines that the kind of handwriting is a character. When the attribute information indicates that the user does not touch the input surface, the determining unit 350 determines that the kind of handwriting is a gesture.

Next, the operation of the handwriting processing apparatus according to the fourth embodiment will be described.

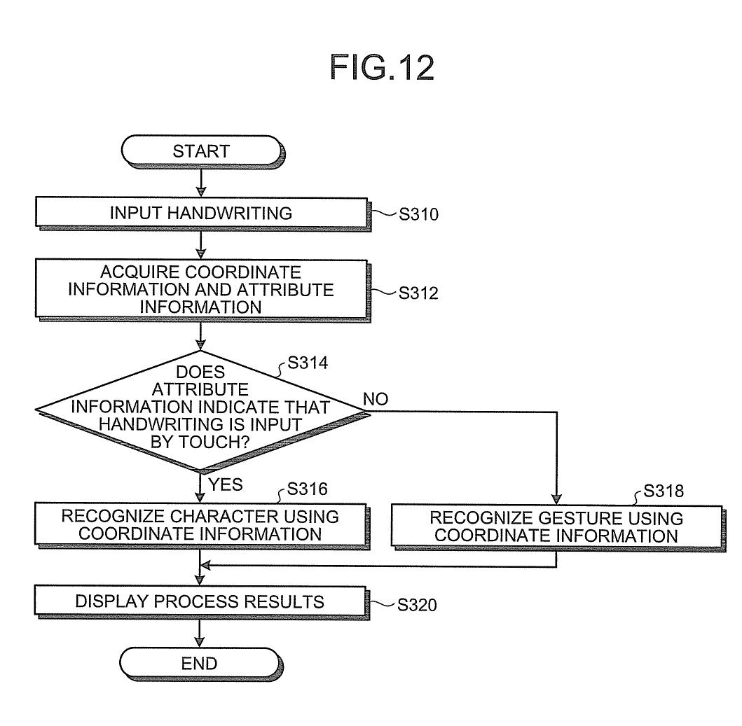

In Step S310 shown in FIG. 12, the user uses a pen to input handwriting to the input unit 310.

In Step S312, the acquiring unit 340 acquires the coordinate information of the handwriting input from the input unit 310 and the attribute information that indicates whether the handwriting is input in a touched manner or a non-touched manner.

In Step S314, the determining unit 350 determines whether the kind of handwriting is a character or a gesture using the attribute information acquired by the acquiring unit 340. When the attribute information indicates that the handwriting is input in a touched manner (Yes in Step S314), the process proceeds to Step S316. When the attribute information indicates that the handwriting is input in a non-touched manner (No in Step S314), the process proceeds to Step S318.

The process from Step S316 to Step S320 is the same as that from Step S16 to Step S20 of the flowchart shown in FIG. 6, and thus a description thereof will be omitted.

In the fourth embodiment, it is determined whether the kind of handwriting is a character or a gesture depending on whether the user touches the input surface to input handwriting, and the character recognizing process or the gesture recognizing process is performed in accordance with the determination result. Therefore, it is possible to determine the kind of input handwriting without lowering usability.

The handwriting processing apparatuses 1, 101, 201, and 301 according to the above-described embodiments each include a control device such as a CPU; a memory device such as a read only memory (ROM) or a RAM; an external memory device such as an HDD, an SSD, or a removable drive device; a display device such as a liquid crystal display; and a coordinate input device such as a touch panel. Each apparatus has a hardware configuration using a general computer.

The handwriting process programs executed by the handwriting processing apparatuses 1, 101, 201, and 301 according to the above-described embodiments are installable or executable files. The handwriting process programs are stored in a computer readable recording medium, such as a CD-ROM, a flexible disk (FD), a CD-R, or a digital versatile disk (DVD), and are provided as a computer program product.

The handwriting process programs executed by the handwriting processing apparatuses 1, 101, 201, and 301 according to the above-described embodiments may be stored in, for example, a ROM in advance and then provided.

The handwriting process programs executed by the handwriting processing apparatuses 1, 101, 201, and 301 according to the above-described embodiments has a module configuration that includes the above-mentioned units (for example, the acquiring unit, the determining unit, the handwriting processing unit, and the display control unit). In an actual hardware structure, the CPU (processor) reads the handwriting process program from the storage medium and executes the read program. Then, each unit is loaded on the main memory device, and the acquiring unit, the determining unit, the handwriting processing unit, and the display control unit are generated on the main memory device.

The invention is not limited to the above-described embodiments, but various modifications and changes of the invention can be made without departing from the scope and spirit of the invention. In addition, a plurality of components according to the above-described embodiments may be appropriately combined with each other to form various inventions. For example, some of all the components according to the above-described embodiments may be removed. In addition, the components according to different embodiments may be appropriately combined with each other.

In the above-described embodiments, it is determined whether the kind of input handwriting is a character or a gesture. Alternatively, it may be determined whether the kind of input handwriting is pointing, a handwritten character, or a design. From various kinds of input handwriting, any two of a character, a gesture, pointing, a handwritten character, and a design may be determined. If the kind of handwriting is determined to be pointing, a process of selecting the position indicated by the coordinate information is performed. If the kind of handwriting is determined to be a handwritten character or a design, the coordinates of handwriting pieces are connected and displayed.

The above-described embodiments may be combined with each other to determine two or more kinds of handwriting. Therefore, the above-described embodiments may be combined with each other to determine whether the kind of input handwriting is a character, a gesture, pointing, a handwritten character, or a picture.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A handwriting processing apparatus comprising:
an acquiring unit configured to acquire coordinate information of handwriting input by an input unit and attribute information, the attribute information indicating a type of input of the handwriting;
a determining unit configured to determine a kind of the handwriting using the attribute information;
a handwriting processing unit configured to perform a character recognizing process or a gesture recognizing process corresponding to the kind of the handwriting using the coordinate information; and
a display control unit configured to control a display unit to display a character recognized if the character recognizing process is performed, and control the display unit to display a execution result of the commend if the gesture recognizing process is performed.

2. The apparatus according to claim 1, wherein the attribute information indicates whether a plurality of handwriting pieces are input at the same time,
the determining unit determines whether the kind of the handwriting is a character or a gesture for performing a predetermined process using the attribute information, and
upon determining that the kind of the handwriting is the character, the handwriting processing unit performs the character recognizing process using the coordinate information, and upon determining that the kind of the handwriting is the gesture, the handwriting processing unit performs the gesture recognizing process using the coordinate information and performs the process indicated by a result of the gesture recognizing process.

3. The apparatus according to claim 2, wherein, when the attribute information indicates that a plurality of handwriting pieces are input, the determining unit determines whether a distance between the handwriting pieces that are input at the same time is greater than a threshold value on the basis of the coordinate information of each of the handwriting pieces, and determines whether the kind of the handwriting is the character or the gesture depending on whether the distance between the handwriting pieces is greater than the threshold value.

4. The apparatus according to claim 1, wherein the attribute information indicates whether the handwriting is input by a finger or a predetermined device,
the determining unit determines whether the kind of the handwriting is a character or a gesture for performing a predetermined process using the attribute information, and
upon determining that the kind of the handwriting is the character, the handwriting processing unit performs the character recognizing process using the coordinate information, and upon determining that the kind of the handwriting is the gesture, the handwriting processing unit performs the gesture recognizing process using the coordinate information and performs the process indicated by a result of the gesture recognizing process.

5. The apparatus according to claim 1, wherein the attribute information indicates whether the handwriting is input to an input surface in a touched manner,
the determining unit determines whether the kind of the handwriting is a character or a gesture for performing a predetermined process using the attribute information, and
upon determining that the kind of the handwriting is the character, the handwriting processing unit performs the character recognizing process using the coordinate information, and upon determining that the kind of the handwriting is the gesture, the handwriting processing unit performs the gesture recognizing process using the coordinate information and performs the process indicated by a result of the gesture recognizing process.

6. A computer program product having a computer readable medium including programmed instructions for processing handwriting that, when executed by a computer, causes the computer to perform:
acquiring coordinate information of handwriting input by an input unit and attribute information, the attribute information indicating a type of input of the handwriting;
determining a kind of the handwriting using the attribute information;
performing a character recognizing process or a gesture recognizing process corresponding to the kind of the handwriting using the coordinate information; and
causing a display unit to display a character recognized if the character recognizing process is performed, and control the display unit to display a execution result of the commend if the gesture recognizing process is performed.

7. A computer-implemented method for handwriting processing, comprising:
acquiring coordinate information of handwriting input by an input unit and attribute information, the attribute information indicating a type of input of the handwriting;
determining a kind of the handwriting using the attribute information;
performing a character recognizing process or a gesture recognizing process corresponding to the kind of the handwriting using the coordinate information; and
causing a display unit to display a character recognized if the character recognizing process is performed, and control the display unit to display a execution result of the commend if the gesture recognizing process is performed.
